(19) United States
(12) Patent Application Publication
(10) Pub. No.: US 2014/0308184 A1
(43) Pub. Date: Oct. 16, 2014

(54) WRAP AROUND FLAME WALL

(71) Applicant: HIGHVAC CORP, (US)

(72) Inventor: EARL VICKERY, Edmond, OK (US)

(73) Assignee: HIGHVAC CORP, Colorado Springs, CO (US)

(21) Appl. No.: 13/859,960

(22) Filed: Apr. 10, 2013

(51) Int. Cl. F01N 3/08; B01D 53/76

(52) U.S. Cl. CPC F01N 3/08; B01D 53/76
USPC 423/210; 422/170

(57) ABSTRACT

A process exhaust waste gas abatement system in the form of a wrap around flame wall module or burner for effectively and efficiently abating a variety of different waste gas streams employing a variety of different fuel-oxidizers. The module includes a variable number of gas outlets provided around a central waste process gas conduit. The gas outlets may either be oriented in a parallel configuration or a converging configuration. The length of the nose piece on the module is between 0.125 and 4 inches to prevent build up of decomposition or oxidation products on the module.

### BACKGROUND OF THE INVENTION

1. Field of the Invention

The present invention is a waste process gas oxidizer that is capable of effectively and efficiently abating a variety of different waste gas streams employing a variety of different fuel-oxidizers.

2. Description of the Related Art

The progression of process technology in the manufacture of semiconductor and Light Emitting Diodes (LEDs) as well as other industries has created challenges for gas abatement systems. The size of manufacturing equipment has increased as processes have evolved creating larger exhaust gas flows. These larger flows have made much of the existing gas abatement equipment obsolete. Process cycles generally start with a purge using nitrogen (N₂). This N₂ purge can displace most all of the oxygen present at the abatement oxidizer module or modules and extinguish the pilot flame or flames until the N₂ concentrations go down.

Because of the increased volumes of exhaust gases that need to be abated, new abatement systems are designed as energy efficient as possible while remaining effective. In addition to increased gas volumes, many of the manufacturing processes are done at pressures less that atmospheric pressure. These reduced pressures are created by placing a pump on the exhaust of the process equipment to draw the process gases out of the equipment. These pumps are usually equipped with a purge gas such as nitrogen (N₂) or possibly air to prevent process gases from damaging certain portions of the pump during use. The purge gas flow can be just a few liters to more than 50 standard liters of gas per minute (SLM). The purge gas is then directed into the main pump exhaust where it mixes with the process gases. This purge gas therefore adds to the volumetric flow of gas that must be handled by the abatement equipment.

A further challenge to current abatement systems is the large variety of process receipts in use today. Some of these processes contain components which are not compatible, and therefore cannot be mingled prior to entering the abatement equipment. Others require very specific conditions and/or additions of components to effectively abate them. Most of these process exhaust streams are most effectively rendered safe through thermal processing, i.e. either the gas stream is burned or it is thermally decomposed.

Another challenge is that process gas streams vary greatly in both composition and flammability. Some of these streams are mostly hydrogen (H₂) gas and, when mixed with an oxidizer, are highly flammable. These streams are considered to be self-destructive. The heat of combustion of the hydrogen gas provides enough thermal energy to thermally or pyrolytically decompose the remaining compounds in the process gas stream or force them to also oxidize. If the major stream component is not flammable, such as for example nitrogen (N₂) gas, then the energy provided by the burning oxidizer fuel is needed to decompose or force oxidization of the remaining gas stream components. The present oxidizer design can accommodate different levels of fuel needed to accomplish abatement of a variety of different gas streams.

The present oxidizer design can also accommodate several different fuel types. These fuel gases include, but are not limited to, hydrogen (H₂), methane (CH₄), ethane (C₂H₄), propane (C₃H₆), and natural gas. Since conditions and fuel types greatly affect burning velocity, it is necessary to ensure that the fuel-oxidizer be protected from unexpected gases that might be in the process gas stream until the fuel—oxidizer mixture is ignited. If, for example, the main component of the process gas stream is nitrogen or another non-flammable gas, this may adversely affect the proper ignition of the fuel-oxidizer mixture by unexpected turbulence and/or reducing the oxygen content necessary to properly ignite the mixture, especially if the oxidizer utilized is the oxygen present in the surrounding air. In some cases, an oxidizer such as air or oxygen can be added to the fuel to give more control of the burning rate, temperature, and position of the burning fuel as it exits one or more of the orifices. To protect the fuel-oxidizer from unexpected gases that might be in the process gas stream until the fuel-oxidizer is ignited, the burner nosepiece must be located between the fuel-oxidizer mixture and the process gas stream until the mixture is burning and stable. A pilot flame, not illustrated, is used to ignite the fuel-oxidizer mixture. It is common to have a distance from the gas nozzle (orifice) and the point where the fuel-oxidizer mixture begin burning. This distance is referred to as the standoff distance. A practical range for length of the nose piece that will accommodate most variation in fuel-oxidizer conditions is between 0.125 and 4 inches (or between 0.3175 cm and 10.16 cm).

### SUMMARY OF THE INVENTION

The present invention is a process exhaust waste gas abatement system in the form of a wrap around flame wall burner. The module or burner is specifically designed to effectively and efficiently abating a variety of different waste gas streams employing a variety of different fuel-oxidizers.

The present oxidizer module design includes a variable number of gas outlets provided around a central waste process gas conduit to accommodate different levels of fuel needed to accomplish abatement of a variety of different gas streams. The number of gas outlets surrounding the central waste process gas conduit can range from a single outlet to a plurality of outlets.

Also, the gas outlets located around the central waste process gas conduit may either be oriented in a parallel configuration or a converging configuration. If the gas outlets are oriented in a parallel configuration, the flame wall created from the fuel emanating from the gas outlets is in the form of a cylindrical flame wall surrounding the conduit.

If the gas outlets are oriented in a converging configuration, the flame wall created from the fuel emanating from the gas outlets is in the form of a cone shaped or conical flame wall surrounding the conduit. If the flame wall is conical, then all of the gas that flows from the central waste process gas conduit must pass directly through the conical flame wall upon exiting the terminal end of the central waste process gas conduit, thereby further insuring the all of the waste gas is abated.

The present oxidizer design can accommodate several different fuel types. These fuel gases include, but are not limited to, hydrogen (H₂), methane (CH₄), ethane (C₂H₄), propane (C₃H₆), and natural gas. Since conditions and fuel types greatly affect burning velocity, it is necessary to ensure that the fuel-oxidizer be protected from unexpected gases that might be in the process gas stream until the fuel-oxidizer mixture is ignited. To protect the fuel-oxidizer from unexpected gases that might be in the process gas stream until the fuel-oxidizer is ignited, the burner nosepiece must be located between the fuel-oxidizer mixture and the process gas stream until the mixture is burning and stable. It is necessary to have a distance from the gas nozzle (orifice) and the point where the fuel-oxidizer mixture begins burning. This distance is referred to as the standoff distance. A practical range for length of the nose piece on the present invention that will accommodate most variations of fuel-oxidizer conditions is between 0.125 and 4 inches (between 0.3175 and 10.16 cm) to prevent disturbance of the flame wall.

### BRIEF DESCRIPTION OF THE DRAWINGS

FIG. 1 is a side view of a first embodiment of an abatement oxidizer module of the present invention having a single fuel-oxidizer point of ignition that is directed in a parallel arrangement with flow from the process gas conduit.

FIG. 2 is a front end view of the first embodiment abatement oxidizer module taken along line 2-2 of FIG. 1.

FIG. 3 is a side view of a second embodiment of an abatement oxidizer module of the present invention having two fuel-oxidizer points of ignition that are directed in parallel arrangement with flow from the process gas conduit.

FIG. 4 is a front end view of the second embodiment abatement oxidizer module taken along line 4-4 of FIG. 3.

FIG. 5 is a side view of a third embodiment of an abatement oxidizer module of the present invention having four fuel-oxidizer points of ignition that are directed in parallel arrangement with flow from the process gas conduit.

FIG. 6 is a front end view of the third embodiment abatement oxidizer module taken along line 6-6 of FIG. 5.

FIG. 7 is a side view of a fourth embodiment of an abatement oxidizer module of the present invention having a plurality of fuel-oxidizer points of ignition that are directed in parallel arrangement with flow from the process gas conduit.

FIG. 8 is a front end view of the fourth embodiment abatement oxidizer module taken along line 8-8 of FIG. 7.

FIG. 9 is a side view of a fifth embodiment of an abatement oxidizer module of the present invention having a single fuel-oxidizer point of ignition that is directed in a converging arrangement with flow from the process gas conduit.

FIG. 10 is a front end view of the fifth embodiment abatement oxidizer module taken along line 10-10 of FIG. 9.

FIG. 11 is a side view of a sixth embodiment of an abatement oxidizer module of the present invention having two fuel-oxidizer points of ignition that are directed in a converging arrangement with flow from the process gas conduit.

FIG. 12 is a front end view of the sixth embodiment abatement oxidizer module taken along line 12-12 of FIG. 11.

FIG. 13 is a side view of a seventh embodiment of an abatement oxidizer module of the present invention having four fuel-oxidizer points of ignition that are directed in a converging arrangement with flow from the process gas conduit.

FIG. 14 is a front end view of the seventh embodiment abatement oxidizer module taken along line 14-14 of FIG. 13.

FIG. 15 is a side view of an eighth embodiment of an abatement oxidizer module of the present invention having a plurality of fuel-oxidizer points of ignition that are directed in a converging arrangement with flow from the process gas conduit.

FIG. 16 is a front end view of the eighth embodiment abatement oxidizer module taken along line 16-16 of FIG. 15.

### DETAILED DESCRIPTION OF THE PREFERRED EMBODIMENT

Referring now to the drawings, there are illustrated several different embodiments of the present invention 10A, 10B, 10C, 10D, 10E, 10F, 10G, and 10H. The invention is a process exhaust waste gas abatement system in the form of a wrap around flame wall burner or module 10A, 10B, 10C, 10D, 10E, 10F, 10G, and 10H. The module 10A, 10B, 10C, 10D, 10E, 10F, 10G, and 10H is specifically designed to effectively and efficiently abating a variety of different waste gas streams 12 employing a variety of different fuels, oxidizers, or fuel-oxidizer mixtures 13.

The design of the present oxidizer module 10A, 10B, 10C, 10D, 10E, 10F, 10G, and 10H includes a variable number of gas outlets, nozzles or orifices 14 provided in a fuel jacket 15 that surrounds a hollow central waste process gas conduit 16 so that the gas outlets 14 can accommodate different levels of fuel 13 needed to accomplish abatement of a variety of different waste gas streams 12 that exit though the terminal end 18 of the conduit 16. As shown in the drawings, the number of gas outlets 14 surrounding the central waste process gas conduit 16 can range from a single outlet 14 to a plurality of outlets 14. For simplicity, neither the source of the fuel and/or oxidizer 13 that feeds into the fuel jacket 15 nor the source of the waste process gas 12 that feeds into the central waste process gas conduit 16 is shown in the drawings.

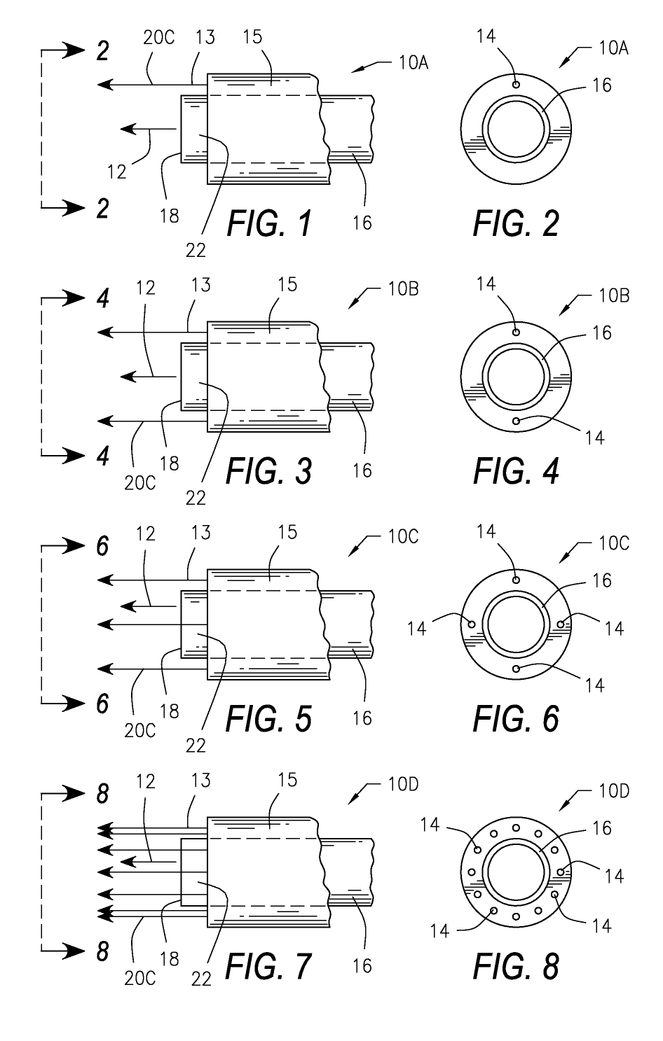

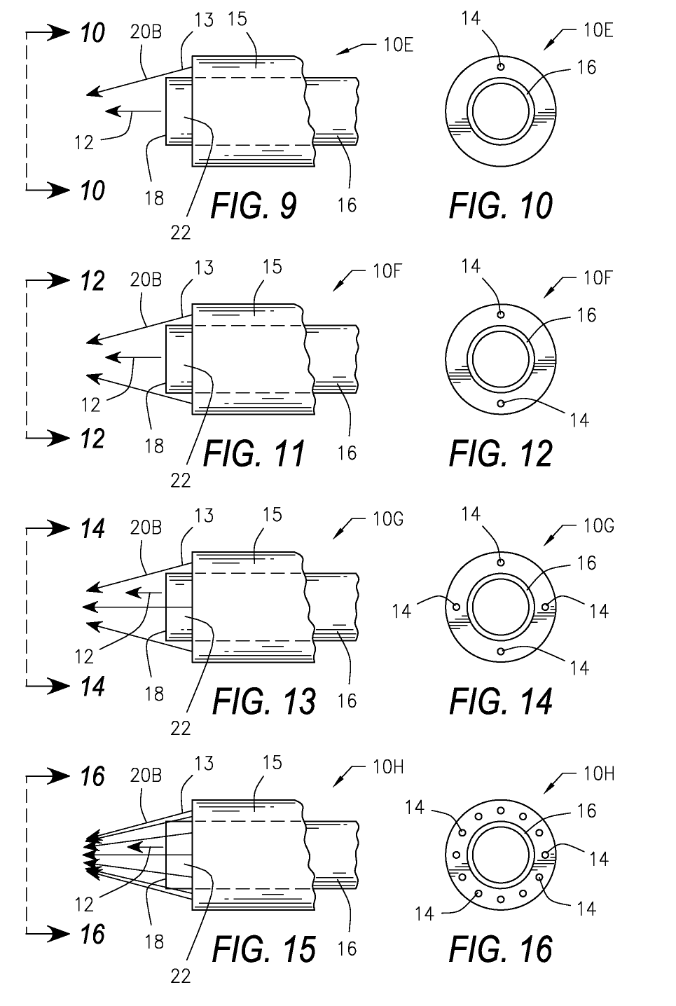

Also, the gas outlets 14 located around the central waste process gas conduit 16 may either be oriented in a parallel configuration as shown in FIGS. 1-8, or alternately, in a converging configuration as shown in FIGS. 9-16.

If the gas outlets 14 are oriented in a parallel configuration, the flame wall 20C created from the burning fuel-oxidizer 13 emanating from the gas outlets 14 is in the form of a cylindrical flame wall 20C surrounding the conduit 16.

Referring now to FIGS. 1-8, there are illustrated a first, second, third, and fourth embodiments of an abatement oxidizer module 10A, 10B, 10C and 10D, respectively, that include one, two, four and a plurality of gas outlets 14, respectively, from which one, two, four and a plurality of fuel-oxidizer points of ignition emanate, respectively, that are all directed in a parallel arrangement to form a cylindrical flame wall 20C surrounding the flow of waste gases 12 emanating from the process gas conduit 16.

If the gas outlets 14 are oriented in a converging configuration, the flame wall 20B created from the fuel 13 emanating from the gas outlets 14 is in the form of a cone shaped or conical flame wall 20B surrounding the conduit 16.

Referring now to the FIGS. 9-16, there are illustrated a fifth, sixth, seventh, and eighth embodiment of an abatement oxidizer module 10E, 10F, 10G and 10H, respectively that include one, two, four and a plurality of gas outlets 14, respectively, from which one, two, four, and a plurality of fuel-oxidizer points of ignition emanate, respectively, that are directed in a converging arrangement with flow of waste gases 12 emanating from the process gas conduit 16.

When a conical flame wall 20B is produced, then all of the waste gases 12 that flows from the central waste process gas conduit 16 must pass directly through the conical flame wall 20B upon exiting the terminal end 18 of the central waste process gas conduit 16, thereby further insuring the all of the waste gases 12 are abated.

The present oxidizer design can accommodate several different types of fuel gases 13. These fuel gases 13 include, but are not limited to, hydrogen (H₂), methane (CH₄), ethane (C₂H₄), propane (C₃H₆), and natural gas. Since conditions and the type of fuel 13 greatly affect burning velocity, it is necessary to ensure that the fuel-oxidizer 13 is protected from unexpected gases that might be in the process gas stream 12 until the fuel-oxidizer mixture 13 is ignited. This is necessary to prevent the flame wall 20C or 20B from being disrupted or disturbed and thereby prevent effective abatement. The nose piece 22 is that portion of the terminal end 18 of the central waste process gas conduit 16 that extends beyond the gas outlets 14. To protect the fuel-oxidizer 13 from unexpected gases that might be in the process gas stream 12 until the fuel-oxidizer 13 is ignited, the burner nose piece 22 must be located between the fuel-oxidizer mixture 13 and the process gas stream 12 until the fuel-oxidizer mixture 13 is burning and the flame wall 20C or 20B is stable. Thus the terminal end 18 of the conduit 16 serves to separate the fuel-oxidizer mixture 13 that is located external to and surrounding the conduit 16 from the process gas stream 12 that is located internally within the hollow conduit 16. It is necessary to have a distance from the gas outlets 14 and the point where the fuel-oxidizer mixture 13 begins burning. This distance is referred to as the standoff distance. A practical range for length of the burner nose piece 22 that will accommodate most variations of fuel-oxidizer conditions is between 0.125 and 4 inches (between 0.3175 and 10.16 cm). Providing a burner nose piece 22 within this length range serves to prevent disturbance of the flame wall 20C or 20B.

While the invention has been described with a certain degree of particularity, it is manifest that many changes may be made in the details of construction and the arrangement of components without departing from the spirit and scope of this disclosure. It is understood that the invention is not limited to the embodiments set forth herein for the purposes of exemplification, but is to be limited only by the scope of the attached claim or claims, including the full range of equivalency to which each element thereof is entitled.

What is claimed is:

1. A process exhaust waste gas abatement system in the form of a wrap around flame wall burner module for abating a variety of different process waste gas streams employing a variety of different fuel-oxidizers comprising:
at least one fuel gas outlet provided in a fuel jacket, said fuel jacket surrounding a terminal end of a central waste process gas conduit such that fuel emanating from the at least one gas outlet forms a flame wall around the conduit.

2. A process exhaust waste gas abatement system according to claim 1 wherein the at least one fuel gas outlet is oriented in a parallel configuration with waste gas flow exiting a terminal end of the central waste process gas conduit to create a cylindrical flame wall.

3. A process exhaust waste gas abatement system according to claim 1 wherein the at least one fuel gas outlet is oriented in a converging configuration with waste gas flow exiting a terminal end of the central waste process gas conduit to create a conical flame wall.

4. A process exhaust waste gas abatement system according to claim 1 wherein there are at least two fuel gas outlets.

5. A process exhaust waste gas abatement system according to claim 4 wherein the fuel gas outlets are oriented in a parallel configuration with waste gas flow exiting a terminal end of the central waste process gas conduit to create a cylindrical flame wall.

6. A process exhaust waste gas abatement system according to claim 4 wherein the fuel gas outlets are oriented in a converging configuration with waste gas flow exiting a terminal end of the central waste process gas conduit to create a conical flame wall.

7. A process exhaust waste gas abatement system according to claim 1 wherein there is a plurality of fuel gas outlets.

8. A process exhaust waste gas abatement system according to claim 7 wherein the plurality of fuel gas outlets is oriented in a parallel configuration with waste gas flow exiting a terminal end of the central waste process gas conduit to create a cylindrical flame wall.

9. A process exhaust waste gas abatement system according to claim 7 wherein the plurality of fuel gas outlets is oriented in a converging configuration with waste gas flow exiting a terminal end of the central waste process gas conduit to create a conical flame wall.

10. A process exhaust waste gas abatement system according to claim 7 wherein the plurality of fuel gas outlets produces a continuous ring of flame around the conduit that is expelling process gases to provide sufficient thermal energy to cause pyrolytic decomposition of components of the process gas stream.

11. A process exhaust waste gas abatement system according to claim 1 further comprising:
the terminal end of a central waste process gas conduit forming a burner nose piece designed to shield from turbulence the flame created by burning fuel as it exits the fuel gas outlets.

12. A process exhaust waste gas abatement system according to claim 11 further comprising:
said nose piece designed to allow use of a wide range of fuel.

13. A process exhaust waste gas abatement system according to claim 11 wherein the burner nose piece is between 0.125 and 4 inches in length.

14. A method to protect a point source ignition for igniting process gas streams comprising:
creating a flame wall of burning fuel encircling a terminal end of a waste process gas conduit such that the flame wall is created from point sources of fuel streams that are directed generally in the direction of flow for a waste gas stream that will exit from the waste process gas conduit,
allowing a waste gas stream to exit the waste process gas conduit so that the waste gas stream exits downstream of the point sources of fuel streams forming the flame wall, and
abating components contained within the waste gas stream pyrolytically within the flame wall of burning fuel.

15. The method of claim 14 wherein the flame wall is cylindrical in shape so that it shields the waste gas stream from contact with air until the waste gas stream has passed out of the waste process gas conduit.

16. The method of claim 14 wherein the flame wall is conical in shape so that the waste gas stream must pass through the conical flame wall upon exiting the waste process gas conduit.

17. The method of claim 14 wherein sufficient fuel is introduced in the point sources of fuel streams to create a flame wall that ensures continuous ignition of process gas streams that are only marginally flammable.
